(19) United States
(12) Patent Application Publication
(10) Pub. No.: US 2006/0279775 A1
(43) Pub. Date: Dec. 14, 2006

(54) Distributed printing control apparatus and print job distribution method

(75) Inventors: Akira Matsumoto, Nagano-ken (JP); Toshihiro Shima, Nagano-ken (JP); Atsushi Yoshino, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/357,096

(22) Filed: Feb. 21, 2006

(30) Foreign Application Priority Data
Feb. 21, 2005 (JP) 2005-44108
Mar. 24, 2005 (JP) 2005-85427
Mar. 24, 2005 (JP) 2005-85264
Mar. 24, 2005 (JP) 2005-85417

(51) Int. Cl. G06F 3/12

(52) U.S. Cl. 358/1.15; 358/1.13

(57) ABSTRACT

This invention provides a control method for a distributed printing system equipped with a display which is capable of distributing print jobs to a plurality of printing apparatuses connected to a network. The control method includes: a candidate destination display control step of displaying candidate destinations selected from the plurality of printing apparatuses as candidates of destination of the distribution of the print jobs. The candidate destination display control step includes the step of displaying a status regarding availability for use for each of the candidate destinations.

### BACKGROUND OF THE INVENTION

1. Field of the Invention

The present invention relates to technologies for distributed printing by distributing print jobs to one or more printing apparatuses connected to a network.

2. Description of the Related Art

Recent years have seen an increase in popularity of printing systems wherein a plurality of printers are connected to a single network and the users are able to select from the plurality of printers for use. This so-called “distributed printing,” which is a technology that completes printing rapidly by distributing the print job to each printer for processing in parallel when multiple copies of a document are to be printed, has also been proposed (in, for example, Japanese Unexamined Patent Application Publication 2002-215369, Japanese Unexamined Patent Application Publication 2003-296062, Japanese Unexamined Patent Application Publication 2003-108274, and Japanese Unexamined Patent Application Publication 2004-234556). In this type of distributed printing, each time a print job is submitted, the printers that are used in the printing, and the number of printers that are used, may change depending on the states of use of the plurality of printers that are connected to the network.

However because the conventional technology provides the user with no interface that is suited to distributed printing, the user cannot know, until the print job has been submitted, which printers will be used in the printing, nor the statuses thereof, and thus it has not been possible to perform preparations for submitting the print jobs, such as warm-ups, and the like. Furthermore, problems have been anticipated that printers far from the location of the user, or printers that other users do not wish to be used, will be selected as printers for the distributed printing.

### SUMMARY OF THE INVENTION

The present invention was created to address these problems, and the object thereof is to provide an extremely user-friendly technology in distributed printing.

The first configuration of the present invention provides a control method for a distributed printing system equipped with a display. The system is capable of distributing print jobs to a plurality of printing apparatuses connected to a network. The control method comprises: a candidate destination display control step of displaying candidate destinations selected from the plurality of printing apparatuses as candidates of destination of the distribution of the print jobs. The candidate destination display control step includes the step of displaying a status regarding availability for use for each of the candidate destinations.

Because the control apparatus according to the present invention displays the distribution destination candidate printing apparatuses, which are candidates for distributing the print job, along with the availability for use status thereof, the state of distribution of the print job can be forecasted when the print job is submitted. This makes it easier to determine whether to execute the distributed printing immediately or whether to do so after waiting awhile.

In order to address at least a portion of the problem described above, the second configuration of the present invention provides a control method for a distributed printing system equipped with a display. The system is capable of distributing print jobs to a plurality of printing apparatuses connected to a network. The control method comprises: a distribution destination candidate display control step of displaying distribution destination candidate printing apparatuses selected from the plurality of printing apparatuses as candidates of destination of the distribution of the print jobs. The control method comprises the steps of: allowing a user input for specifying at least one of the candidate destinations displayed on the display and for causing an execution of a warm-up process of the specified the candidate destinations; and controlling the specified the candidate destinations to execute the warm-up process in response to the user input.

In the control apparatus according to the present invention, the structure is such that a user input is accommodated to specify one or more of the distribution destination candidate printing apparatuses displayed on the Display to execute warm up operations, thus enabling the warming up of the distribution destinations prior to the print job being sent. This enables the print job to be completed more quickly.

Note that, in the present specification, the “warm up” refers broadly to the process of creating the state wherein the printer is able to begin image formation. This process includes, for example, a variety of processes such as warming up the fuser unit, initializing the imaging controller, performing diagnostics for jams and other error states, and performing imaging adjustment processes such as detecting density. Moreover, the control apparatus and display device may, respectively, be equipped on a client computer included in the distributed printing system, or may be equipped in a distributed printing control apparatus, described below.

The third configuration of the present invention provides a control method for a distributed printing system equipped with a display, the system being capable of distributing print jobs to a plurality of printing apparatuses connected to a network. The control method comprises: a distributor information display step of displaying distributor-information for identifying a distributing printing apparatus selected by a user from the plurality of printing apparatuses, the distributing printing apparatus being a distributor of the print jobs in the distributed printing system; a competent destination information display step of displaying competent-information for identifying printing apparatuses capable of printing functions available in the distributing printing apparatus as competent destinations for a user selection; and a candidate destination information display step of displaying candidate-information for identifying candidate destinations selected by the user from among the competent destinations, the candidate destinations being destinations of the distributed print jobs.

Here the “printing functions” include whether or not the printer can print on both sides of the page, whether or not the printer can print in color, the sizes of the paper upon which the printer can print, etc. Additional functions that are not directly related to printing, such as the printer having a display panel, are not included. The “competent destinations” are those printing apparatuses that have functions that include the functions that are possessed by the distributing printing apparatus as functions that relate to printing, and include printing apparatuses that are not of the identical model as the distributing printing apparatus, but rather are printing apparatuses that are of a different model from the distribution source printing apparatus. For example, when it comes to the ability to print on both sides of the page, a printing apparatus capable of printing on both sides of the page encompasses being a printing apparatus capable of printing on only one side of a page. Moreover, when it comes to whether or not the printing apparatus can print in color, a printing apparatus capable of printing in color encompasses being a printing apparatus that can print in monochrome only.

In the distributor information display step, either information for identifying a distribution source printing apparatus inputted manually by the user may be displayed, or the setup device may search for printing apparatuses on the network that can serve as distribution source printing apparatuses and display information for specifying the distribution source printing apparatus that is selected by the user from the search results “(information for specifying a printing apparatus” may use, for example, the IP address assigned to the printing apparatus on the network, the name of the printing apparatus, the manufacturing number, or the like).

The fourth configuration of the present invention provides a control method as combinations of the first to third configuration. This combination provides a control method for a distributed printing system equipped with a display, the system being capable of distributing print jobs to a plurality of printing apparatuses connected to a network. The control method comprises: a candidate destination display control step of displaying candidate destinations selected from the plurality of printing apparatuses as candidates of destination of the distribution of the print jobs. The candidate destination display control step include the steps of: a distributor information display step of displaying distributor-information for identifying a distributing printing apparatus selected by a user from the plurality of printing apparatuses, the distributing printing apparatus being a distributor of the print jobs in the distributed printing system; a competent destination information display step of displaying competent-information for identifying printing apparatuses capable of printing functions available in the distributing printing apparatus as competent destinations for a user selection; and a candidate destination information display step of displaying candidate-information for identifying candidate destinations selected by the user from among the competent destinations; a status display step of displaying a status regarding availability for use for each of the distribution destination candidate printing apparatuses. The control method comprises the steps of: allowing a user input for specifying at least one of the candidate destinations displayed on the display and for causing an execution of a warm-up process of the specified candidate destinations; and controlling the specified candidate destinations to execute the warm-up process in response to the user input.

The present invention can be structured as a printing apparatus that includes the distributed printing control apparatus internally, instead of being structured as the control apparatus described above. Moreover, the present invention is not limited to the form of a device invention in this way, but rather may be embodied as a process invention, such as a process for distributing print jobs. Furthermore, the present invention may be embodied in a variety of forms such as being formed as a computer program (including firmware) for structuring these methods and devices, or as a graphical user interface, or in the form of a recording medium on which is recorded this type of computer program, or as a data signal that is embedded in a carrier wave, including the aforementioned computer program.

When the present invention is structured as a computer program or a recording medium on which such a program is recorded, or as another computer program product, the structure may be as an entire program for controlling the printing apparatuses, or may be structured as only the part of a program that achieves the function of the present invention. Moreover, a flexible disk, a CD-ROM, a DVD-ROM, a magneto-optical disk, an IC card, a ROM cartridge, a punch card, a printing medium whereon is printed symbols such as a bar code, a memory device internal to a computer (such as a RAM or ROM memory, or the like), an external memory device, or any other type of computer-readable medium can be used as the recording medium.

### BRIEF DESCRIPTION OF THE DRAWINGS

FIG. 1 is an explanatory diagram illustrating schematically the structure of a distributed printing system 1000 as a first example of embodiment according to the present invention.

FIG. 2 is an explanatory diagram illustrating the structure of each component provided in the distributed printing system 1000.

FIG. 3 is an explanatory diagram showing a graphical user interface W1 that is used in the distribution destination setup process in the first example of embodiment according to the present invention.

FIG. 4 is an explanatory diagram illustrating the procedures in the distribution destination setup process in the first example of embodiment according to the present invention.

FIG. 5 is an explanatory diagram illustrating a text data file F1 for storing the details of the setup.

FIG. 6 is an explanatory diagram illustrating a graphical user interface W2 that is used in the distributed printing process in the first example of embodiment according to the present invention.

FIG. 7 is an explanatory diagram illustrating a routine in the distributed printing process in the first example of embodiment according to the present invention.

FIG. 8 is an explanatory diagram illustrating a routine in the distributed printing execution process in the first example of embodiment according to the present invention.

FIG. 9 is an explanatory diagram illustrating a screen Sc of a personal computer 100 in a first example of embodiment according to the present invention.

FIG. 10 is an expanded view of a notification area Z3 in the first example of embodiment according to the present invention.

FIG. 11 is an explanatory diagram illustrating an example of the correspondence relationship between each of the printer indicators and the distribution destinations.

FIG. 12 is an explanatory diagram showing schematically the structure of a distributed printing system 100000 as a second example of embodiment according to the present invention.

FIG. 13 is an explanatory diagram showing the structure of each component in the distributed printing system 100000 in the second example of embodiment according to the present invention.

FIG. 14 is an explanatory diagram illustrating one example of a distribution destination printer and a distribution destination candidate printer setup screen W1 in the second example of embodiment according to the present invention.

FIG. 15 is an explanatory diagram illustrating one example of a distribution destination printer setup screen W2 in the second example of embodiment according to the present invention.

FIG. 16 is an explanatory diagram illustrating the flow of the setup of the distribution printers in the second example of embodiment according to the present invention.

FIGS. 17A to 17D are explanatory diagrams illustrating the distribution destination candidate printer setup screens W3 through W6, as alternate examples of the second example of embodiment according to the present invention.

FIG. 18 is an explanatory diagram illustrating the structure of a setup device 10000A as an alternate form of the second example of embodiment according to the present invention.

FIG. 19 is an explanatory diagram illustrating a distribution destination candidate printer setup screen as an alternate example of the second example of embodiment according to the present invention.

### DESCRIPTION OF THE PREFERRED EMBODIMENT

Next, forms of embodiment of the present invention will be explained based on an example of embodiment, following the sequence below:
A. Structure of a Distributed Printing System in a First Example of Embodiment According to the Present Invention
B. Distribution Destination Setup Process in the First Example of Embodiment According to the Present Invention
C. Distributed Printing Process in the First Example of Embodiment According to the Present Invention
D. Indicator Display Process in the First Example of Embodiment According to the Present Invention
E. Alternate of the First Example of Embodiment According to the Present Invention
F. Structure of a Distributed Printing System in a Second Example of Embodiment According to the Present Invention
G. Structure of a Graphical User Interface According to the Second Example of Embodiment According to the Present Invention.
H. Setting Up the Distributed Printing in the Second Example of Embodiment According to the Present Invention
I. Alternate Form of the Second Example of Embodiment According to the Present Invention

### A. STRUCTURE OF A DISTRIBUTED PRINTING SYSTEM ACCORDING TO A FIRST EXAMPLE OF EMBODIMENT ACCORDING TO THE PRESENT INVENTION

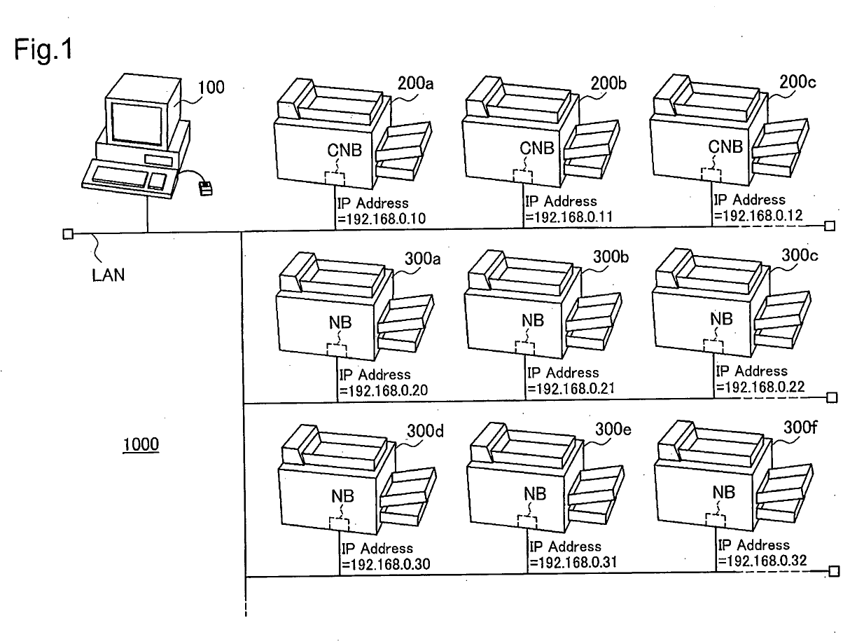

FIG. 1 is an explanatory diagram illustrating schematically the structure of a distributed printing system 1000 in a first example of embodiment according to the present invention. This distributed printing system 1000 comprises a personal computer 100, three distribution function-installed printers 200a, 200b, and 200c in which are installed custom network boards CNBs, and six standard printers 300a through 300f, in which standard network boards NB are installed. These are connected through a local area network LAN. Each of the plurality of distribution function-installed printers 200a, 200b and 200c, and the plurality of standard printers 300a through 300f has its own unique structure.

The standard network boards NB are boards for connecting the standard printers 300a through 300f directly to the local area network LAN for use as network printers. On the other hand, the custom network boards CNB are boards in which the additional distributed printing functions are installed on the standard network boards NB. The distributed printing functions, in the first example of embodiment, are functions for partitioning a received print job and distributing and transmitting a part thereof to the plurality of standard printers 300a through 300f in which the standard network boards NB are installed, and to the local printer itself (described below). Note that the standard network boards NB and the custom network boards CNB are equipped with CPUs and memory, not shown.

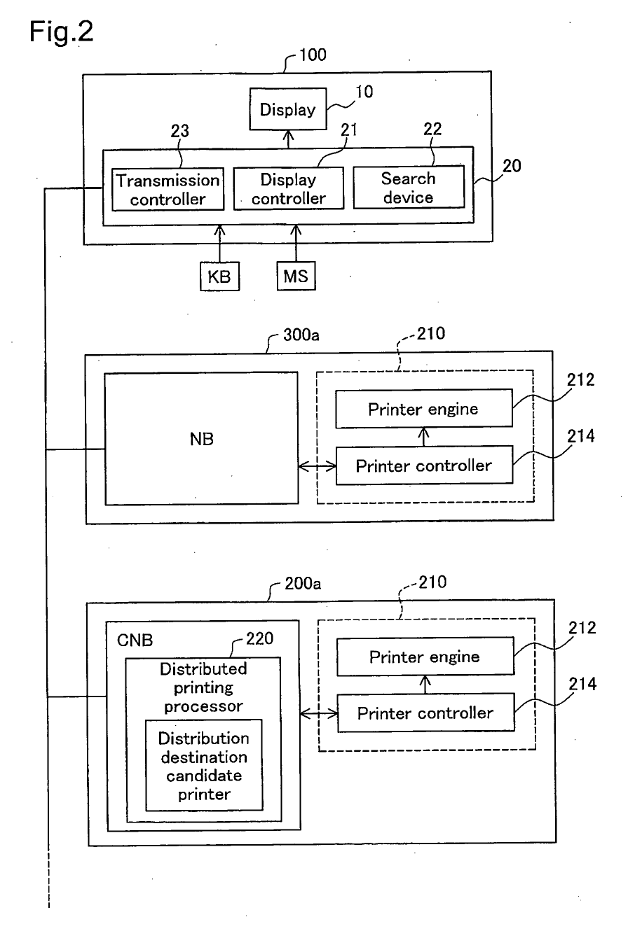

FIG. 2 is an explanatory diagram illustrating the structure of each component provided in the distributed printing system 1000. The personal computer 100 comprises a Display 10 and a processing part 20. The processing part 20 comprises a Transmission controller 23, a Search device 22, and a Display controller 21. The Display controller 21 can display a graphical user interface, described below, on the Display 10 according to instructions from the custom network board CNB. A keyboard KB and a mount MS are connected to the processing part 20 to convey user input to the processing part 20. The personal computer 100 is structured in this way so as to be able to function as a user interface in the printing process.

The Transmission controller 23 functions as an interface between the local area network LAN and the personal computer 100. The Search device 22 searches for a specific printer from among the three distribution function-installed printers 200a, 200b, and 200c, and the six standard printers 300a through 300f, which are connected to the local area network LAN. The details of the search function will be described below.

The standard printer 300a comprises a printer main unit 210 for executing the printer, and a standard network board NB. The printer main unit 210 comprises a printer engine 212, and a printer controller 214. The printer controller 214 is a computer comprising a CPU, a RAM, and a ROM, not shown. The printer controller 214 receives a print job that has been received by the custom network board CNB, and controls the printer engine 212 to execute the printing.

The distribution function-installed printer 200a has the same structure as the standard printer 300a except for the point that a custom network board CNB is provided instead of the standard network board NB. The custom network board CNB provides a Distributed printing processor 220 equipped with distributed printing functions. The Distributed printing processor 220 distributes printer jobs to distribution destinations set up by the setup process, described below. Note that in the first example of embodiment, this Distributed printing processor 220 corresponds to the “control apparatus” in the patent claims.

### B. DISTRIBUTION DESTINATION SETUP PROCESS IN THE FIRST EXAMPLE OF EMBODIMENT ACCORDING TO THE PRESENT INVENTION

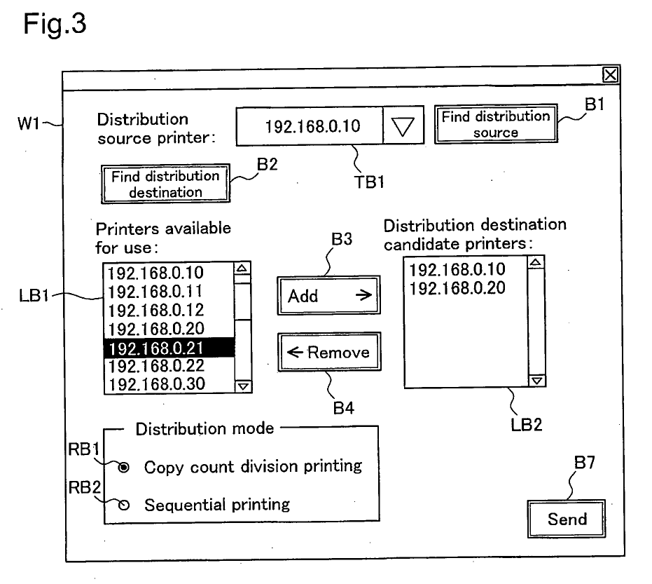

FIG. 3 is an explanatory diagram illustrating a graphical user interface W1 that is used in the distribution destination setup process in the first example of embodiment accordant to the present invention. The graphical user interface W1 is an interface screen that is displayed on a personal computer 100 in order to perform the distribution destination setup process. The distribution destination setup process, in the first example of embodiment, is the process for setting up in advance which of the six standard printers 300a through 300f to use as the distribution destination for each of the three distribution function-installed printers 200a, 200b, and 200c to perform distributed printing.

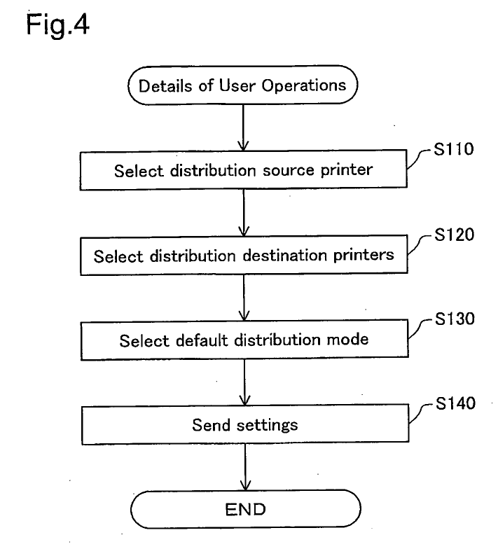

FIG. 4 is an explanatory diagram illustrating the procedures in the distribution destination setup process in the first example of embodiment according to the present invention. In step S110, the user uses the graphical user interface W1 to select the desired distribution source printer for which to set up the distribution destination. The selection of the distribution source printer is performed using the “Find distribution source” button B1 and the text box TB1. When the user clicks the “Find distribution source” button B1, the printers that can serve as the distribution source in the text box TB1 are searched on the local area network LAN. The printers that can serve as the distribution source are printers that have the distribution functions installed. Specifically, they are the printers with the functions of the distribution function-installed printers 200a, 200b, and 200c, which are installed with the custom network board CNB.

The personal computer 100 lists in the text box, as a pull-down menu, the IP addresses for each of the distribution function-installed printers 200a, 200b, and 200c that have been found (shown in FIG. 1). In the first example of embodiment, three IP addresses “192.168.0.10”, “192.168.0.11” and “192.168.0.12” are listed. Of the three IP addresses, when the user clicks the “192.168.0.10” IP address in the pull-down menu, “192.168.0.10” will be displayed in the text box TB1 (FIG. 3). This enables the setting up of the distribution destination that is the distribution function-installed printer 200a that has the address “192.168.0.10”.

In Step S120, the user uses the graphical user interface to select the distribution destination for the distribution function-installed printer 200a. The selection of the distribution destination uses the “Find distribution destination” button B2, the two list boxes LB1 and LB2, the “Add” button B3, and the “Remove” button B4. When the user clicks the “Find distribution destination” button B2, the local area network LAN is searched for printers that can be distribution destinations. Specifically, these are those printers, from among the total of nine printers (that is, the three distribution function-installed printers 200a, 200b, and 200c, and the six standard printers 300a through 300f) that are functioning.

The personal computer 100 lists, in the list box LB1 (FIG. 3) the individual IP addresses of the nine printers that are found, 200a, 200b, 200c, and 300a through 300f (FIG. 1). In the present example, nine IP addresses in the range of “192.168.0.10” through “192.168.0.32” are listed. Note that the IP addresses “192.168.0.31” and “192.168.0.32” are displayed through scrolling.

Through selecting any of the addresses from among the nine IP addresses, the user is able to set up a distribution destination printer with the distribution function-installed printer 200a as the distribution source. Specifically, this is done by the user clicking one of the nine IP addresses and then clicking the “Add” button B3. In the example in FIG. 3, the IP addresses “192.168.0.10” and “192.168.0.20” have already been set up as distribution destinations, and “192.168.0.21” has been selected. In this state, when the “Add” button B3 is clicked, “192.168.0.21” is added to the list as the third distribution destination in the list box LB2.

In Step S130, the user performs the initial setup for the distribution mode. In the first example of embodiment, two different modes, the copy count division print mode and the sequential print mode, can be selected as the distribution mode. The copy count division print mode is a mode wherein a print job for printing 100 copies, for example, is divided into print jobs of 25 copies each for each of the four printers. The sequential mode is a mode wherein the print job for, for example, printing 100 copies is divided into print jobs of one copy each and sent to whichever of the printers, of the four printers, that is able to do the printing, sequentially, until the 100 copies has been achieved. These modes are setup by selectively clicking one of the two radio buttons RB1 or RB2.

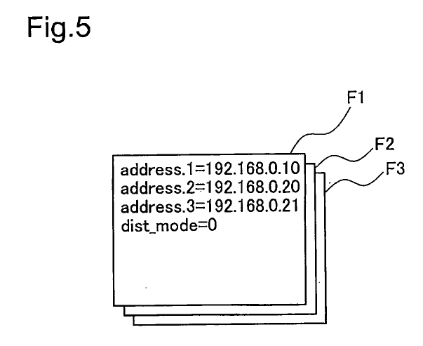

In Step S140, the user clicks the “Send” button B7 to send to the distribution function-installed printer 200a the details of the settings. The details of the settings are sent as, for example, a text data file F1 as shown in FIG. 5. The text data file stores, as data, the three IP addresses “192.168.0.10”, “192.168.0.20”, and “192.168.0.21”, and the “dist_mode=0” that indicates the copy count division print mode.

The distribution function-installed printer 200a stores, in the Distributed printing processor 220 (FIG. 2) the contents of the text data file F1 that has been sent. Doing so enables distributed printing to be performed using the contents of the settings as the initial settings even when a distributed print job is received from another computer on the local area network LAN.

This type of distributed printing setup process can also setup the other distribution function-installed printers 200b and 200c in the same manner. Note that the distribution destinations for the distribution function-installed printers 200a, 200b, and 200c may or may not be the same distribution destinations.

### C. DISTRIBUTED PRINTING PROCESS IN THE FIRST EXAMPLE OF EMBODIMENT ACCORDING TO THE PRESENT INVENTION

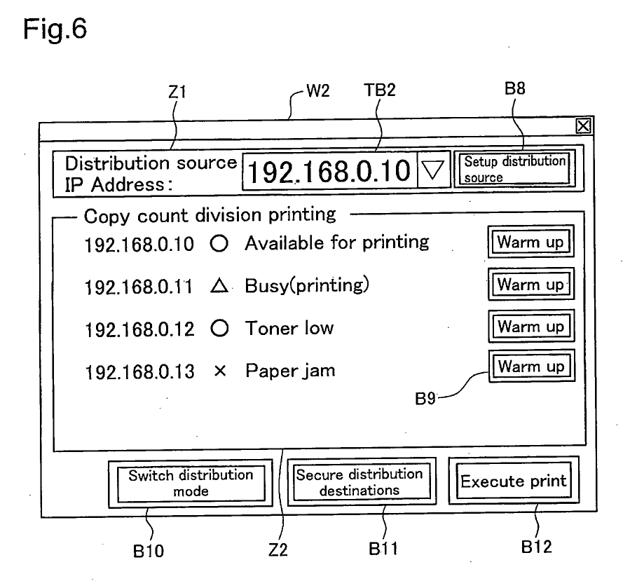

FIG. 6 is an explanatory diagram illustrating a graphical user interface W2 used in the distributed printing function in the first example of embodiment according to the present invention. The graphical user interface W2 is an interface screen that is displayed on the personal computer 100 for executing the distributed printing process. The graphical user interface W2 comprises a distribution source setting area Z1, used for selecting the distribution source, and a distribution destination status display area Z2, used for displaying the statuses of the distribution destinations.

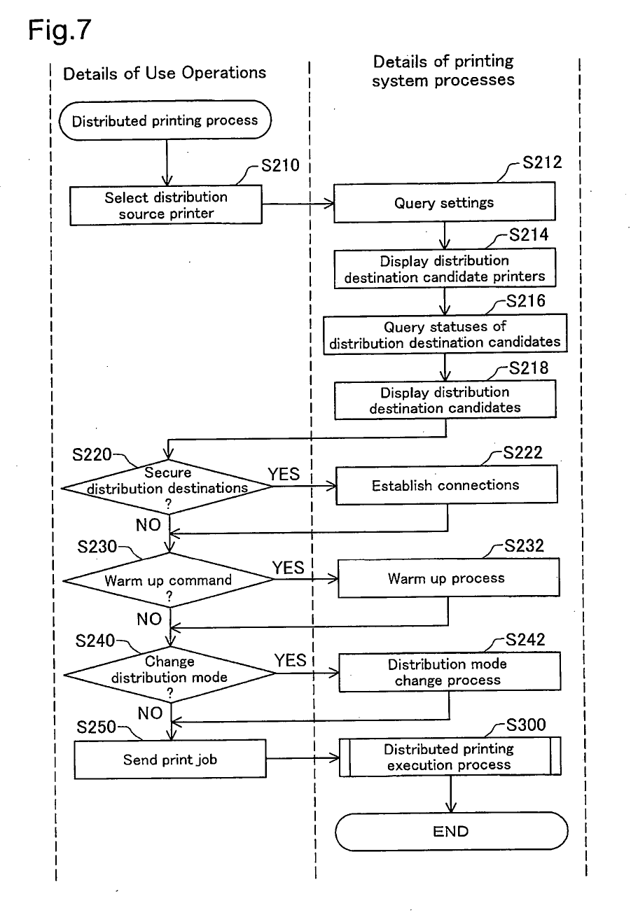

FIG. 7 is an explanatory diagram showing a routine for the distribution printing process in the first example of embodiment according to the present invention. In Step S210, the distribution source setup area Z1 in the graphical user interface W2 is used to select the distribution source printer that will be the distribution source for the distributed printing. The selection of the distribution source printer is performed following the same procedure as the distribution destination setup procedure using the “Setup distribution sources” button B8 and the text box B2 in the distribution source setup area Z1. In this example, the distribution function-installed printer 200a is selected as the distribution source. Note that until the distribution source is selected, the distribution destination status display area Z2 will be blank (which state is not shown in the figure).

In Step S212, the personal computer 100 references the details of the settings for the distribution function-installed printer 200a according to the selection of the distribution source printer. The Distributed printing processor 220 of the distribution function-installed printer 200a sends, to the personal computer 100, data indicating the contents of the text data file F1 in response to this inquiry.

In Step S214, the personal computer displays the IP addresses of the printers that are the distribution destinations, based on the data that has been received. The display of the IP addresses is performed in the distribution destination status display area Z2.

In Step S216, the Distributed printing processor 220 queries the statuses of the distribution destination printers, and sends the results to the personal computer 100. This query is performed through reading out specific status data from the MIB (Management Information Base), not shown, provided for each of the distribution destination candidate printers, using the SNMP protocol.

The specific status data can acquire the following objects if, for example, the data is as specified by RFC 1514:

(1) The hrPrinterDetectedErrorState object;

(2) The hrPrinterStatus object; and

(3) The prtConsoleDisplayBufferText object.

The hrPrinterDetectedErrorState object stores data indicating whether or not the printer is in an error state, such as a paper jam. The hrPrinterStatus object stores data indicating the operating state of the printer such as whether or not printing is in progress. The prtConsoleDisplayBufferTest object stores text data indicating text that is not displayed in the Display, not shown on the printer.

In Step S218, the personal computer 100 displays in the distribution destination status display area Z2 the statuses of the distribution destination candidate printers, based on the objects received from the Distributed printing processor 220. In the example in FIG. 6, the status display in the distribution destination status display area Z2 displays directly a symbol (a circle, a triangle, or an X) that indicates availability for printing, and also displays the text that is displayed in the Display of the printer (not shown).

The display of the circle, triangle, or X, which indicates the availability for printing, is determined based on the following criteria in the first example of embodiment.

(1) A circle is displayed when there is no error at the destination distribution printer and the printer is not busy;

(2) The triangle is displayed when there is no error at the distribution destination printer, and the printer is busy; and

(3) The X is displayed when the distribution destination printer is in an error state.

The above not only makes it possible to check the distribution destinations for a distributed print job, but also makes it possible to view the status of the various distribution destination printers without having to go to the locations of the individual distribution destination printers. Note that the statuses of the individual distribution destination printers are liable to change, and so the distributed printing controller part 220 should be structured so as to update the processes in Step S212 through Step S218 at, for example, on second intervals.

After understanding the status of the various distribution destination printers, the user can click the “Print” button B12 to send the print job. However, depending on the status, the “Print” button B12 can also be clicked after performing the “secure distribution destination” process (Step S220), the “warm up instruction” process (Step S230) or the “change distribution mode” process (Step S240).

The “secure distribution destination” process (Step S220) is a process for securing the distribution destination printer, given the status that changes over time. The “secure” distribution destination” process (Step S220) can be performed by clicking the “Secure distribution destination” button B11 after highlighting the IP address by clicking the IP address that is displayed in, for example, the distribution destination status display area Z2.

Doing so maintains a connection between the personal computer 100 and the printer for which the process for securing the distribution destination is to be performed. The result is that access by other users is rejected, thus securing the distribution destination.

The warm up instruction process (Step S230) is the process for starting the initiation of the preliminary warm up prior to sending the print job. This process can be performed at each distribution destination through clicking the “Warm up button” B9 that is displayed in the distribution status display area Z2.

Doing this makes it possible to start warming up the distribution destinations prior to sending the print job, thus making it possible to shorten the time it takes to complete the print job. However, the structure may be such that the warm up is cancelled if the print job has not been sent by the time a specific amount of time (for example, one minute) has elapsed. Doing this makes it possible to cancel with certainty unnecessary warm-ups when the user has cancelled the transmission of the print job.

Here the “warm-up,” in the first example of embodiment refers to warming up the fuser; however, the meaning is not limited thereto, but rather may refer to a process for creating a state wherein the printer can commence image formation such as, for example, warming up the fuser, initializing the image controller, performing self diagnostics on error states such as jams, performing image adjustment processes such as detecting the density, and so forth.

Note that, ideally, the structure should be such that the connections between the personal computer 100 and the printers that are subjected to the distribution destination securing process are maintained from the time that a “Warm up button” B9 is clicked to the time that the print job is sent. This is because doing so can avoid situations wherein another user uses the printer that is being warmed up.

The distribution mode modification process (Step S240) is a process for modifying the distribution mode from the initial settings to different settings. This process can be executed by clicking the “Switch distribution mode” button B10 that is displayed in the distribution destination status display area Z2. For example, in the status in FIG. 6, when the “Switch distribution mode” button B10 is clicked, not only is the distribution mode switched, but also the display of the “copy count division print” that is displayed in the distribution destination status display area Z2 is switched automatically to “sequential printing.”

After these setups have been performed as required, the user sends the distributed print job (Step S300). Doing so starts the distributed printing execution process.

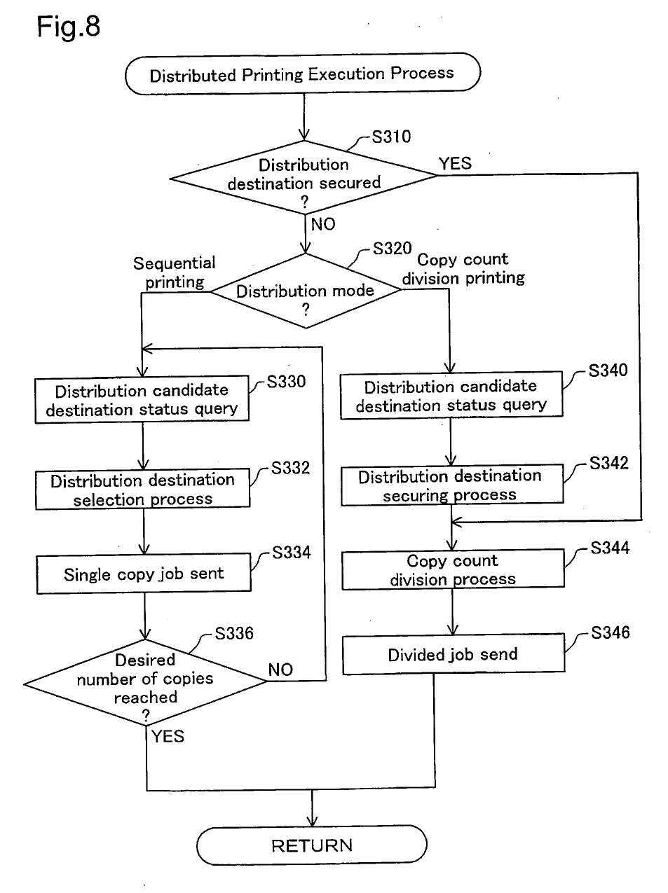

FIG. 8 is an explanatory diagram illustrating a routine in the distributed printing execution process in the first example of embodiment according to the present invention. In Step S310, the distributed printing processing part 220 of the distribution function-installed printer that is the distribution source (FIG. 2) determines whether or not the distribution destinations have been secured. When the distribution destinations have been secured, then the process advances to Step S344. On the other hand, if the distribution destinations have not been secured, then the process advances to Step S320.

In Step S320, the Distributed printing processor 220 advances the process to either Step S330 or Step S340 depending on the distribution mode that has been set.

In Step S330 to Step S336, the distributed printing process is performed in the sequential print mode. In Step S330, the Distributed printing processor 220 queries the statuses of each of the distribution destination candidates using the method described above. The result of the query is that the printers that are able to print are selected as distribution destinations (Step S332), and print jobs are sent that each print one copy (Step S334). This type of process is repeated sequentially until the total number of copies has been reached (Step S336). The total number of copies to be printed is the total number of printings requiring printing in the distributed print jobs.

In this way, in the sequential print mode jobs can be sent one at a time depending on the status of the distribution destinations, which change over time, and thus even if all of the printers are busy or have errors, the printing can be performed thereafter when the statuses change. Moreover, even if there is a failure in printing due to an error, or the like, no print jobs will be sent to a stopped distribution destination. In this way, the sequential print mode has the feature of being able to achieve printing with excellent robustness.

In the processes in Step S340 through Step S346, the distributed printing process is performed in the copy count division distribution mode. In Step S340, the Distributed printing processor 220 queries the statuses of each of the distribution destination candidates using the process described above. Connections are secured and maintained using, as the distribution destinations, the printers that, as the results of the queries, can perform the printing (Step S342).

In Step S344, the Distributed printing processor 220 divides the total number of copies to be printed by the number of distribution destinations secured to calculate the number of copies to be printed by each of the distribution destinations. The Distributed printing processor 220 send to each of the distribution destinations print jobs by overwriting the number of copies with the number of copies in the print received from the computer 100 (Step S346).

In this way, the copy count division print mode performs printing of the number of copies that have been set for the distribution destinations that have been secured in advance, and thus has the feature of making it easy to pick up the printed copies without the chance of printed materials (from other print jobs) being mixed in between copies in the distributed print job.

The distributed printing system according to the present invention can operate as described below, for example, because data regarding the statuses of the individual distribution destination printers can be provided in the distribution destination status display area Z2:

(1) If many printers are busy and the print job is urgent, then, in consideration of the other users, the distributed print job is submitted momentarily after the number of available printers has increased;

(2) When it is necessary to print a large job with extremely high urgency, the distributed print job can be submitted immediately through switching to the sequential print mode. Doing so enables the printed copies to be recovered quickly while performing maintenance, such as resupplying the paper to the distribution destinations, after the job has been submitted; and

(3) When it is necessary to print an extremely large job, the distributed print job can be submitted after securing the distribution destinations after switching to the copy count division mode. If the number of copies is extremely large, then this is the most appropriate method because it reduces the number of copies from other jobs that are mixed in, which would increase the work in collecting the printouts. Furthermore, in the structure in the first example of embodiment, the distributed print job can be submitted after sequentially securing the distribution destinations, as described above.

In this way, in the distributed printing system according to the present invention, the users are able to perform the appropriate distributed printing processes depending on the statuses of the various distribution destinations, the number of copies to print, and the level of urgency.

### D. INDICATOR DISPLAY PROCESS IN THE FIRST EXAMPLE OF EMBODIMENT ACCORDING TO THE PRESENT INVENTION

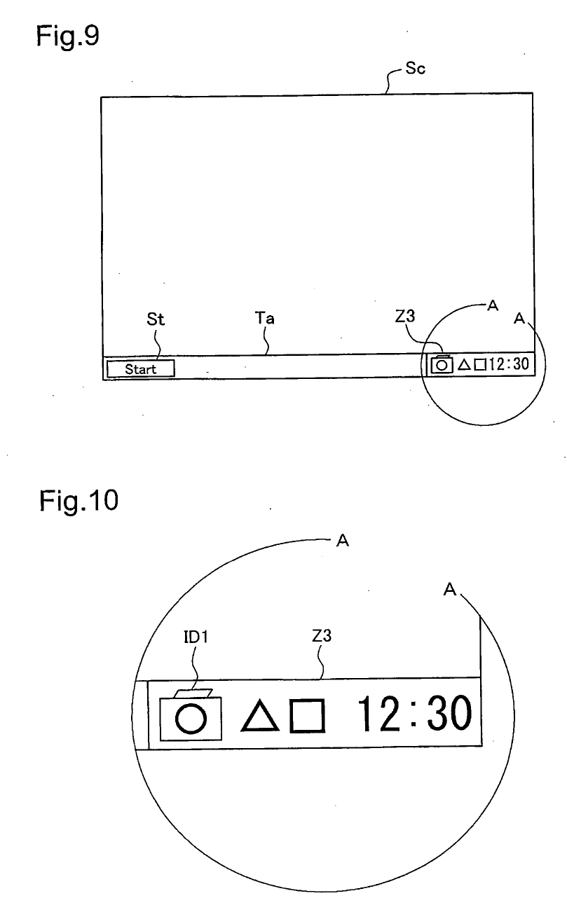

FIG. 9 is an explanatory diagram illustrating the screen Sc of the personal computer 100 in the first example of embodiment according to the present invention. The personal computer 100 uses Windows (as the operating system. The screen Sc has a task bar Ta displayed at the bottom. The task bar Ta has a “Start” button St and a notification area Z3. The notification area Z3 is an area that is always displayed, regardless of the state of the application.

FIG. 10 is a close-up view of the notification area Z3 in the first example of embodiment according to the present invention. The notification area Z3 displays a printer indicator ID1, displayed according to the status of the distribution destination printers set up for the distribution source that is ultimately selected. A circle mark is displayed in the center part of the printer indicator ID1. This indicates that at least one of the distribution destinations is available for printing.

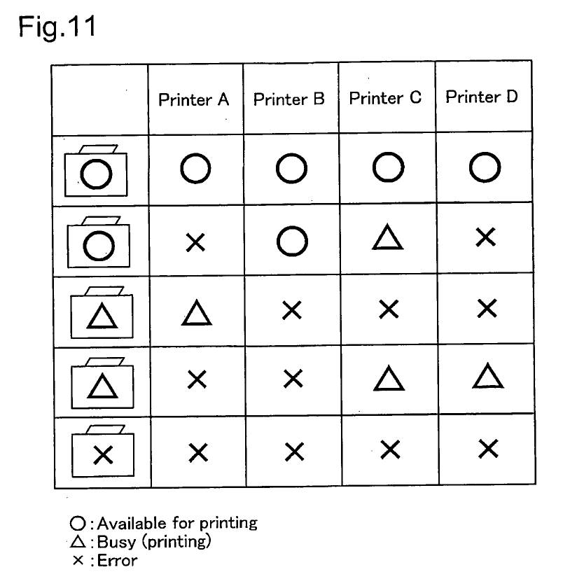

FIG. 11 is an explanatory diagram illustrating an example of the correspondence relationship between the various printer indicators and the distribution destinations. In the first example of embodiment, the correspondence relationship is structured as shown below.

(1) At least one of the destination printers is available for printing: The circle mark is displayed in the center part.

(2) There are errors in all of the distribution destinations: The X mark is displayed in the center part.

(3) Other statuses: The triangle mark is displayed in the center part.

The “other statuses” refers to there being no distribution destinations available for printing and at least one of the distribution destinations being in a busy state.

In this way, icons that display the overall status of the distribution destinations can be displayed at all times, which has the benefit of making it possible to submit print jobs with the appropriate timing.

### E. ALTERNATE EXAMPLE OF THE FIRST EXAMPLE OF EMBODIMENT

Note that the present invention is not limited to the example of embodiment or form of embodiment described above, but rather can be embodied in a variety of forms in a range that does not deviate from the intent thereof.

E-1. In the example of embodiment described above, the text data file F1 that stores the details of the settings was stored on the distribution function-installed printer side; however, for example, the structure may be such that the text data file F1 is stored in the computer 100, or may be configured so as to be stored in both. If configured so that the text data file F1 is stored by the computer 100, there is the benefit of being able to have different settings for each computer 100.

E-2. In the example of embodiment described above, the distribution destination statuses are displayed on a display equipped by the computer 100; however, instead the structure may be such that the display is on the distribution function-installed printer side.

E-3. While in the example of embodiment described above, the distribution function-installed printer side performed the processes of querying the status of the distribution destinations, and searching for and controlling distribution destinations, the structure may be, for example, such that these functions are performed by the computer 100.

E-4. In the example of embodiment described above, the indicator that is displayed in the notification area presupposes an application to a distributed printing system, but rather may also be applied to a system that does not assume distributed printing. In this case, the structure may be such that the status of the printer that handles the administration of the client print job may be displayed as it is, or the structure may be such that the display is in an abbreviated state.

Moreover, the present configuration can also be applied to a different operating system, the Macintosh® operating system. With a Macintosh, the display of the indicator can be in the notification area at the upper right of the screen.

In the example of embodiment described above, the IP addresses were used in specifying the distribution destinations, in searching for distribution destination printers, in specifying the distribution destination printers in the distribution destination specification file, but, an MAC address, or another ID that can specify a device uniquely may be used instead.

### F. CONFIGURATION OF A DISTRIBUTED PRINTING SYSTEM ACCORDING TO A SECOND EXAMPLE OF EMBODIMENT

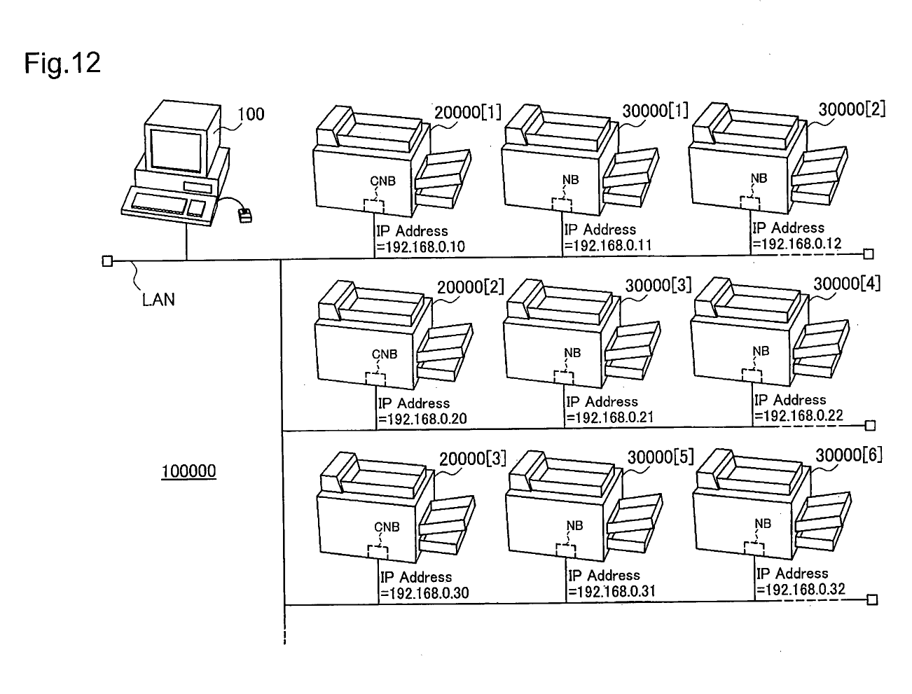

FIG. 12 is an explanatory diagram illustrating schematically the structure of a distributed printing system 100000 as one example of embodiment according to the present invention. This distributed printing system 100000 comprises a personal computer 100, a plurality of printers 20000(1), 20000(2), 20000(3) . . . , installed with custom network boards CNBs, and a plurality of printers 30000(1), 30000(2), 30000(3), . . . installed with standard network boards. These are connected via a local area network LAN. In the below, these printers 20000(1), 20000(2), 20000(3), . . . equipped with custom network boards CNB are termed, together, the “printers 20000,” and the printers 30000(1), 30000(2), 30000(3), . . . equipped with standard network boards are termed the “printers 30000.” Note that in the example shown, on a single personal computer 100 is shown, but the present invention is not limited thereto, but rather may be set to any number. In the present example of embodiment, the printers 20000 and the printers 30000 are laser printers wherein printing is performed through adhering toner to printing paper.

The custom network boards CNB and the network boards NB are network interfaces for the exchange of print jobs over the local area network LAN. These are each assigned the respective IP addresses. Moreover, the custom network boards CNB have functions that generate print jobs for distribution and sending to other printers, from print jobs received from the personal computer 100 when performing distributed printing, and then send these print jobs to other printers.

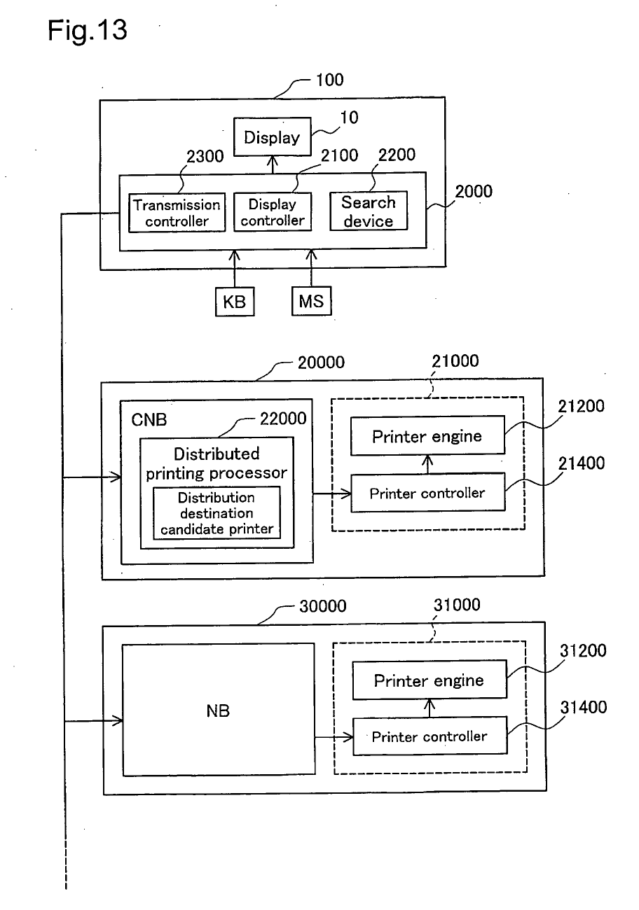

FIG. 13 is an explanatory diagram illustrating the structure of each device in the distributed printing system. The personal computer 100 not only has functions for sending a print job to any of the printers on the local area network, selected by the user, but also the custom network board CNB that is installed in the printer 20000 that is selected as the distribution source printer, which serves as the distribution source for the print job, has functions by which to setup the distribution destination candidate printers that serve as candidates for the distribution destinations for the print job when distributed printing is performed. The personal computer 100 corresponds to the setup device in the present invention. In the below, the personal computer 100 is also termed the setup device 10000.

The setup device 10000 is equipped with a Display 1000, a CPU 2000, a keyboard KB and a mouse MS. The CPU 2000 is equipped with a Display controller 2100, a searching part 2200, and a Transmission controller 2300. These functional blocks are structured in software by the CPU 2000 reading and executing specific computer programs stored in a memory, not shown. At least a portion of these functional blocks may instead be structured in hardware.

The Display controller 2100 displays, on the Display 1000, a graphical user interface for setting up the distribution destination candidate printers. The user sets up the distribution source printers and the distribution destination candidate printers through the graphical user interface displayed on the Display 100 through operating the keyboard KB and the mouse MS. The searching part 2200 performs searches, among the plurality of printers on the local area network LAN, as described below, for candidates for the distribution source printers and searches for printers of the same types as the distribution source printers when performing the setup. The Transmission controller 2300 sends to the distribution source printer the settings that have been set up by the user. The graphical user interface, and the method of setting up the distribution source printers and the distribution destination candidate printers will be described in detail below.

The printer 20000 is equipped with a printer main unit 21000 that performs the printing and a custom network board CNB. The printer main unit 21000 is equipped with a print engine 21200 and a printer controller 21400. The printer controller 21400 is a computer equipped with a CPU, a RAM, and a ROM, not shown, and receives print jobs through the custom network board CNB from the personal computer 100 or another printer 20000, to control the printer engine 21200 to perform the printing.

The custom network board CNB is equipped with a Distributed printing processor 22000. The custom network board CNB is equipped with a CPU and a memory, not shown, and the CPU functions as a distributed printing processor 2200 through the CPU performing a specific program. The printer 20000, equipped with a custom network board CNB, can serve as the distribution source printer. The distributed printing processor 2200 registers the distribution destination candidate printers set up by the setup device 10000. In the present example of embodiment, the distribution destination candidate printers are registered through storing in memory a file that stores the IP addresses of the distribution destination candidate printers as described below. The Distributed printing processor 2200 selects the appropriate distribution destination printers as the distribution destinations for the print job, from the distribution destination candidate printers that have been recorded, and determines the printers when performing distributed printing, and distributes and sends the print jobs to the distribution destination printers to perform the distributed printing. The distribution destination candidate printers and distribution destination printers are, of course, included in the printers 20000 that are installed. Note that when the distribution destination printers have been determined for the distribution source printer, the conditions of the “on-line status” and the “not-busy status” are set in advance as the conditions for determining the distribution printers for selecting immediately the printers for executing the distributed printing.

The printer 30000 is equipped with a printer main unit 31000 that performs the printing, and a network board NB. The printer main unit 31000 is equipped with a printer engine 312000 and a printer controller 31400. The printer controller 31400 is a computer equipped with a CPU, RAM, and ROM, not shown, and receives print jobs through the network board NB from the personal computer 100 or a printer 20000, and controls the print engine 31200 to perform the printing.

### G. STRUCTURE OF THE GRAPHICAL USER INTERFACE

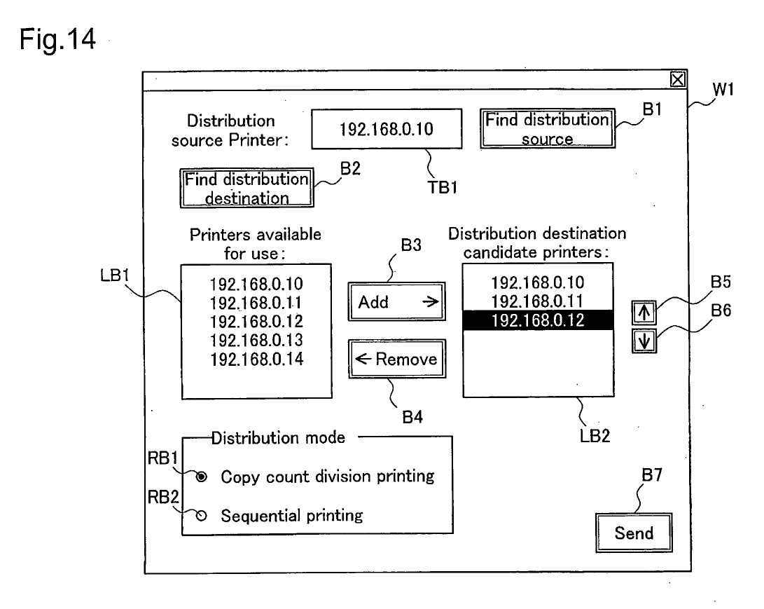

FIG. 14 is an explanatory diagram illustrating an example of a distribution source printer and distribution destination candidate printer setup screen W1, shown in the Display 1000 of the setup part 10000. The setup screen W1 displays the graphical user interface that is shown.

The graphical user interface is equipped with a “Find distribution sources” button B1 for instructing the setup device 10000 to search for candidates as distribution source printers, to become the distribution sources for the print jobs, or in other words, to search for printers 20000 that are equipped with the custom network boards CNB, and the graphical user interface is further equipped with a text box TB1 for displaying the IP address of a distribution source printer that has been selected by the user from the candidates that have been found. The selection and setup of the distribution source printers will be described below.

The graphical user interface is further equipped with a “Find distribution destination” button B2 for instructing the setup device 10000 to search for the same type of printer as the distribution source printer selected by the user already, a list box LB1 for displaying the IP addresses of the distribution destination printer candidates, which are the search results, and a list box LB2 for displaying the distribution destination candidate printers selected by the user from among the distribution destination candidates (IP addresses) displayed in the list box LB1.

Moreover, the graphical user interface is equipped with an “Add” button B3 for adding, as a distribution destination candidate printer, a printer selected from among the distribution destination printer candidates displayed in the list box LB1, and a “Remove” button B4 for deleting printers from the distribution destination candidate printers displayed in the list box LB2.

Moreover, the graphical user interface is equipped with a “Up” button B5 for increasing the level of priority of a distribution destination candidate printer, displayed in the list box LB2, and a “Down” button B6 for decreasing the level of priority. In the present example of embodiment, the IP addresses of the distribution destination candidate printers are displayed, in the list box LB2, in the order of their priority as distribution destination candidate printers. Doing this makes it possible to setup the distribution destination candidate printers in the priority order desired by the user.

Moreover, the graphical user interface is equipped with radio buttons for specifying the method of distributing the print jobs. In the present example of embodiment, there is a radio button RB1 for specifying the “Copy count division printing” and a radio button RB2 for specifying the “Copy printing.”

Moreover, the graphical user interface is equipped with a “Send” button B7 for instructing the setup device 10000 to send to the distribution source printer the settings from the setup screen W1.

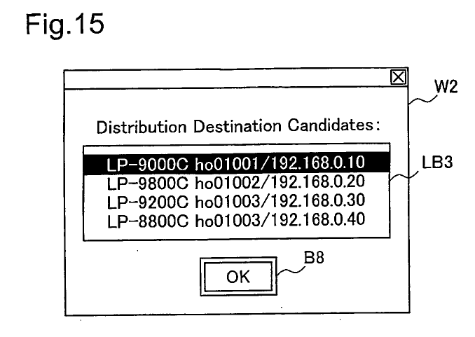

FIG. 15 is an explanatory diagram illustrating an example of a setup screen W2 for the distribution source printer. This setup screen W2 is a screen that is displayed when the “Find distribution source” button B1 is pressed in the setup screen W1, shown in FIG. 14, when searching for candidates for the distribution source printer. In the setup screen W2 are displayed a list box LB3 for displaying the type names, host names, and IP addresses of the printers that can serve as candidates for the distribution source printers, and a “OK” B8 button for the user to decide on a distribution source printer from the printers displayed in the list box LB3. In the example shown in the figure, the highlighted printer 20000 with the model name “LP-9000C,” host name “ho01001,” and an IP address of “192.168.0.10” has been selected as the distribution source printer.

### H. SETTING UP THE DISTRIBUTED PRINTING

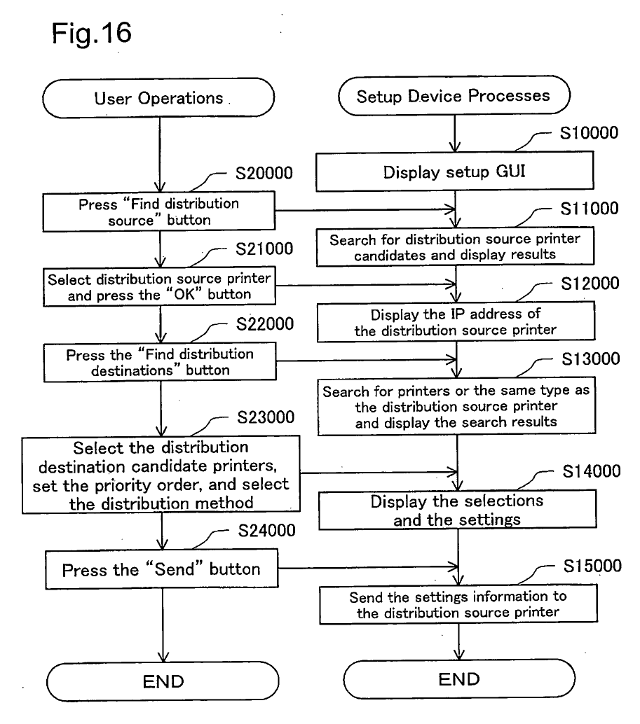

FIG. 16 is an explanatory diagram illustrating the setup process flow for distributed printing. The setup of the distribution printing is performed using the setup screens W1 and W2 shown in FIG. 14 and FIG. 15. On the right-hand side of the figures is shown the flow of the operations in the setup device 10000, and on the left-hand side of the figures is shown the flow of the user operations.

First of all, the CPU 2000 of the setup device 10000 uses the Display controller 2100 to display, on the Display 1000, the graphical user interface (setup screen W1), shown in FIG. 14, for performing the setup (Step S10000).

Next the user operating the mouse MS in the setup screen W1 to press the “Find distribution source” button B1 (Step S20000). In respond, the CPU 2000 searches the local area network LAN for candidates for the distribution source printer, and uses the Display controller 2100 to display in the list box LB3 of the distribution source printer setup screen W2, shown in FIG. 15, the results of the search (Step S11000).

Next, in the setup screen W2, the user uses the mouse MS to select a distribution source printer from the printers shown in the list box LB3, and clicks the “OK” button B8 (Step S21000). In response, the CPU 2000 uses the Display controller 2100 to display, in the text box TB1 of the setup screen W1, the IP address of the distribution source printer selected by the user (Step S12000).

Next, the user uses the mouse MS in the setup screen W1 to press the “Find distribution destinations” button B2 (Step S22000). In response, the CPU 2000 uses the Search device 2200 to search on the local area network LAN to search for printers of the same model as the distribution source printer and uses the Display controller 2100 to display the search results in the list box LB1 (Step S13000).

Next, the user uses the mouse MS to select distribution destination candidate printers from the candidates for the distribution destination candidate printers displayed in the list box LB1, and to determine the priority order thereof, and selects the distribution method for the print jobs (Step S23000). The CPU 2000, in response to these operations, uses the Display controller 2100 to display in the setup screen W1 the selections that have been made and the selections that have been accepted (Step S140).

Furthermore, when the user uses the mouse MS to press the “Send” button B7 (Step S240) the CPU 2000 uses the Transmission controller 2300 to send the settings to the distribution source printer (Step S15000).

The distribution source printer that has received the settings information registers the distribution destination candidate printers and the priorities thereof. In the present example of embodiment, this registration is performed through storing in memory a file that is written with the IP addresses of the distribution destination candidate printers, along with the associated priorities of the distribution destination candidate printers. The distribution source printer selects the distribution destination printers according to the registered information to perform the distributed printing.

The setup device 10000 as described above can setup the distribution destination candidate printers as desired by the users for the distribution source printers using the graphical user interface shown in FIG. 14. This is able to increase the convenience of the distributed printing system 100000.

### I. ALTERNATE EXAMPLE OF THE SECOND EXAMPLE OF EMBODIMENT

While several forms of embodiment of the present invention have been explained above, the present invention is in nowise limited to these types of forms of embodiment, but rather can be embodied in a variety of ways in a range that does not deviate from the intent thereof. For example, the following alternate forms are possible.

### I-1. ALTERNATE EXAMPLE 1

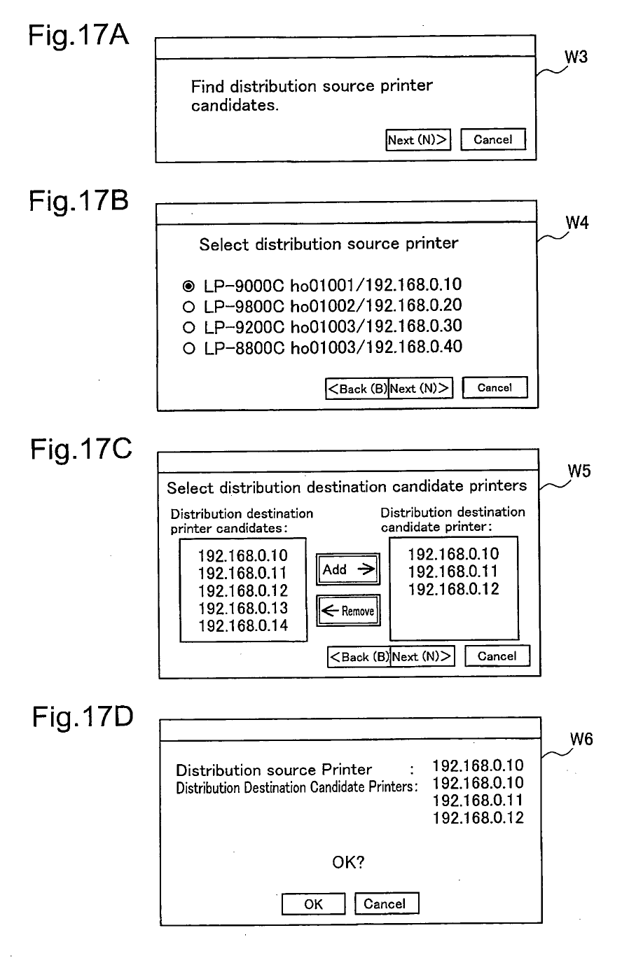

FIGS. 17A to 17D are explanatory diagrams illustrating setup screens W3 through W6 of the distribution destination candidate printers as alternative examples. In this alternative example, the distribution destination candidate printer setup is done in the form of a so-called “wizard.”

Firstly, the CPU 2000 of the setup device 10000 uses the Display controller 2100 to display the screen W3, shown in FIG. 17A, to display to the users the search for the candidate for the distribution source printers. In this screen W3, when the user presses the “Next” button, the CPU 2000 uses the searcher part 2200 to search the local area network LAN for the printers 20000 that are candidates for the distribution source printers, and uses the Display controller 2100 to display the search results on the screen W4 shown in FIG. 17B. In the present alternate form, the model name, host name, and IP address of the printers are displayed. Moreover, along with the distribution source printers, radio buttons for the user to select one of the printers as the distribution source printer are also displayed in this screen W4.

In the screen W4, the distribution source printer is selected by the user, and when the user presses the “Next” button, the CPU 2000 uses the Display controller 2100 to display the screen W5, shown in FIG. 17C. The screen W5 is the screen for the user to select the distribution destination candidate printers, and displays the list boxes LB1 and LB2, the “Add” button B3, and the “Remove” bottom B4 of the settings screen W1 shown in FIG. 14. Note that in this alternate form, levels of priority are not set for the distribution destination candidate printers.

In the screen W5, the distribution destination candidate printers are selected by the user, and when the “Next” button is pressed, the CPU 2000 uses the Display controller 2100 to display the screen W6 for confirming the settings, shown in FIG. 17D. When the user presses the “OK” button in the screen W6, the CPU 2000 uses the Transmission controller 2300 to send the settings to the distribution source printer.

In the distributed printing system 100000, the distribution destination candidate printers can be setup for the distribution source printer according to the desires to the user using this graphical user interface, in the same way as in the example of embodiment described above. This is able to increase the convenience of the distributed printing system 100000. Note that the example of embodiment described above has the benefit of the user being able to set up the distribution source printer and the distribution destination candidate printers in the same screen.

### I-2. ALTERNATE EXAMPLE 2

In the example of embodiment described above, various settings were set up using list boxes and radio buttons in the setup screens W1 and W2 shown in FIG. 14 and FIG. 15; however, the present invention is not limited thereto. For example, check boxes, pull-down menus, etc. can be used instead.

### I-3. ALTERNATE EXAMPLE 3

In the example of embodiment described above, the setup device 10000 performs the search for the candidates for the distribution source printer, and the user selects the distribution source printer from among the candidates; however, the present invention is not limited thereto. For example, in a situation such as wherein the user already knows which printer on the local area network LAN will serve as the distribution source printer, the user can manually type in the IP address for the distribution source printer into the text box TB1.

### I-4. ALTERNATE EXAMPLE 4

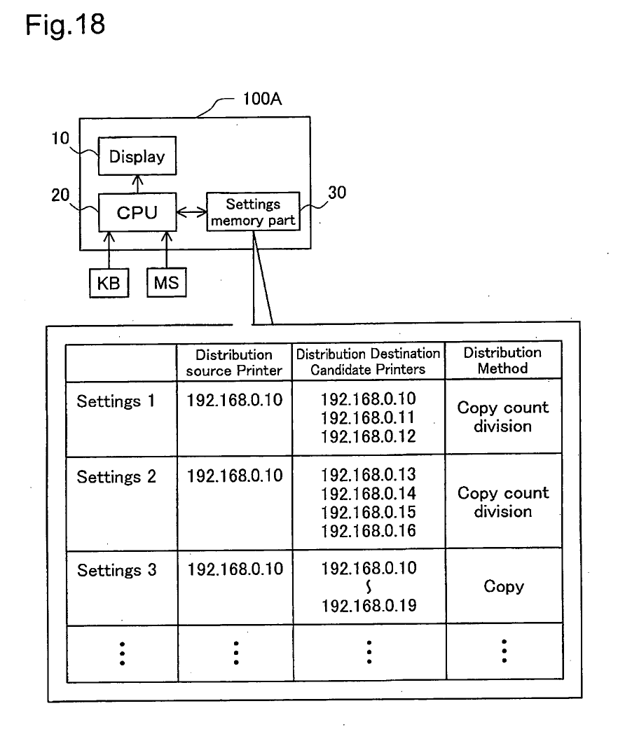

FIG. 18 is an explanatory diagram illustrating the structure of a setup device 10000A as an alternate example. This setup device 10000A, as with the setup device 10000 in the example of embodiment described above, has a Display 1000, a CPU 2000, a keyboard KB and a mouse MS, and also has a settings memory part 3000. This settings memory part 3000 has stored, in advance, a plurality of settings information for distributed printing. The contents thereof can be set as desired by the user. The settings memory part 3000 can store the settings for various types of distributed printing for, for example, a single distribution source printer, as shown in the figure. Doing this enables the user to select the desired settings from multiple settings details, to setup the distributed printing rapidly.

### I-5. ALTERNATE EXAMPLE 5

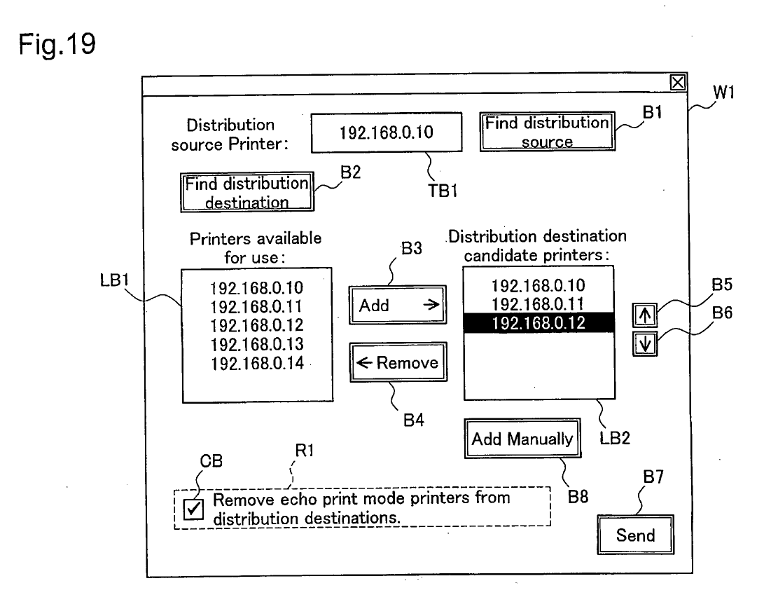

FIG. 19 is an explanatory diagram illustrating a setup screen W7 for distribution destination candidate printers, as an alternate example, as is shown in the figure, this setup screen W7 displays a graphical user interface that is essentially the same as the setup screen W1 shown in FIG. 14. As with the settings screen W1, this graphical user interface is equipped with a “Find distribution source” button B1, a text box TB1, a “Find distribution destinations” button B2, list boxes LB1 and LB2, an “Add” button B3, a “Remove” button B4, an “Up” button B5, a “Down” button B6, and a “Send” button B7.

The graphical user interface in the present alternate example is equipped also with an “Add manually” button B8, and a display area R1.

The “Add manually” button B8 is a button for the user to add a printer manually as a distribution destination candidate printer, without the printer being found and displayed in the list box when the search for the distribution destination printer candidates is performed, for some reason such as the power not being turned on. When the user presses the button B8, and input screen (not shown) is displayed for the user to input the IP address of a printer the user wishes to add as the distribution destination candidate printer, and when the user inputs the IP address in this screen, the IP address is added to the list box LB2.

The display area R1 is provided with a checkbox CB for setting whether or not to enable the condition of “Remove echo print mode printers from distribution destinations.” In the present example embodiment, the “echo print mode” refers to a print mode that allows printing even when there is the potential for the printing results to be faint during printing, because the amount of printer toner remaining is less than 1%. As is shown in figure, when this checkbox CB is enabled, then when the settings are recorded in the distribution source printer, the condition of “Remove echo print mode printers from distribution destinations” is added to the determination conditions for the distribution destination printers. The checkbox CB corresponds to the setup part in the present invention.

Note that in the graphical user interface in the setup screen W7 is not provided with the radio buttons RB1 and RB2 for setting the method of print job distribution as shown in the setup screen W1, but these radio buttons RB1 and RB2 make also be provided as well. Moreover, in the present alternate example, the “Remove echo print mode printers from distribution destinations” is added as a condition to the determination conditions of the distribution destination printers, but other conditions may also be added as well.

By adding the “Add manually” button B8 and the display area R1 to the graphical user interface, as described above, the convenience of the distributed printing system 100000 can be improved even further.

### I6. ALTERNATE EXAMPLE 6

In the example embodiments described above, printers of the same type as the distribution source printer were searched when searching for the distribution destination printer candidates, but the present invention is not limited to thereto, and instead of printers that have at least the functionality possessed by the distribution source printer for the functions (printer functions) related to the printing may be searched. The “Printers that have at least the functionality possessed by the distribution source printer for the functions (printer functions) related to the printing” refers to a printer having functions that include the functions possessed by the distribution source printer, as the printer functions such as whether or not there is double-sided printing, whether or not there is color printing, the sizes of the paper that can be used, and so forth. For example, when it comes to whether or not there is double-sided printing, a printer that can print double-sided assumes the ability to print single-sided. Moreover, when it comes to whether or not a printer can print in color, a printer that can print in color includes the functions of a printer that is able to print only in black-and-white. Moreover, a printer that can print on A4-sized paper, on A3-sized paper, and on B4-sized paper includes the functions of a printer that is able to print only on A4-sized paper and on B4-sized paper. This also further increases the convenience of the distributed printing system.

Note that when searching distribution destination printer candidates, if printers having at least the printer functions possessed by the distribution source printers are searched, then, when searching, the setup device 10000 may perform a process that receives a list of the printer functions in the distribution source printer and lists of the printer functions of the printers that are subjected to the searching, and compares these lists to determine whether or not the printer functions of the printers that are subjected to the searching include the printer functions of the distribution source printer. These decisions may be made through preparing and storing in advance tables that record the inclusion relationships for these printer functions, and then referencing these tables.

Finally, the present application incorporates, by reference, the following four Japanese patent applications that are the foundations of the priority claims of the present application:

(1) Japanese Patent Application 2005-044108 (Application Date: Feb. 21, 2005)

(2) Japanese Patent Application 2005-085427 (Application Date: Mar. 24, 2005)

(3) Japanese Patent Application 2005-085264 (Application Date: Mar. 24, 2005)

(4) Japanese Patent Application 2005-085417 (Application Date: Mar. 24, 2005).

What is claimed is:

1. A control method for a distributed printing system equipped with a display, the system being capable of distributing print jobs to a plurality of printing apparatuses connected to a network, comprising:
a candidate destination display control step of displaying candidate destinations selected from the plurality of printing apparatuses as candidates of destination of the distribution of the print jobs, wherein
the candidate destination display control step include the steps of:
a distributor information display step of displaying distributor-information for identifying a distributing printing apparatus selected by a user from the plurality of printing apparatuses, the distributing printing apparatus being a distributor of the print jobs in the distributed printing system;
a competent destination information display step of displaying competent-information for identifying printing apparatuses capable of printing functions available in the distributing printing apparatus as competent destinations for a user selection;
a candidate destination information display step of displaying candidate-information for identifying candidate destinations selected by the user from among the competent destinations; and
a status display step of displaying a status regarding availability for use for each of the distribution destination candidate printing apparatuses; wherein
the control method comprises the steps of:
allowing a user input for specifying at least one of the candidate destinations displayed on the display and for causing an execution of a warm-up process of the specified candidate destinations; and
controlling the specified candidate destinations to execute the warm-up process in response to the user input.

2. A control method for a distributed printing system equipped with a display, the system being capable of distributing print jobs to a plurality of printing apparatuses connected to a network, comprising:
a candidate destination display control step of displaying candidate destinations selected from the plurality of printing apparatuses as candidates of destination of the distribution of the print jobs, wherein
the candidate destination display control step includes the step of displaying a status regarding availability for use for each of the candidate destinations.

3. The control method according to claim 2, wherein
the control method is executed by one of the plurality of printing apparatuses, and is able to receive print jobs sent through the network and able to distribute the print jobs to at least a part of the plurality of printing apparatuses.

4. The control method according to claim 2, wherein
the display is equipped by a client system connected to the network;
the candidate destination display control step include the step of displaying a status indicator determined in accordance with a status of the availability for use of each of the candidate destinations, in a notification area showing a program status indicator indicative of a program status of a running program on the display, wherein
the status includes three kinds of statuses of available-for-use, printing-in-process, and not-able-to-print for each of the candidate destinations, wherein
the status indicator indicates the status of available-for-use when the statuses includes at least one status of available-for-use whereas the status indicator indicates the status of not-able-to-print when all of the statuses are not-able-to-print.

5. The control method according to claim 2, wherein
the status indicator indicates the status of printing-in-process when the statuses includes at least one status of printing-in-process and does not include the status of available-for-use.

6. A control apparatus for a distributed printing system equipped with a display, the system being capable of distributing print jobs to a plurality of printing apparatuses connected to a network, comprising:
a distribution destination candidate display controller that displays candidate destinations selected from the plurality of printing apparatuses as candidates of destination of the distribution of the print jobs, wherein
the distribution destination candidate display controller displays a status regarding availability for use for each of the candidate destinations.

7. A computer program product for causing a distributed printing system equipped with a display, the system being capable of distributing print jobs to a plurality of printing apparatuses connected to a network, the computer program product comprising:
a computer readable medium; and
a computer program stored on the computer readable medium, the computer program comprising a program for causing the system to display candidate destinations selected from the plurality of printing apparatuses as candidates of destination of the distribution of the print jobs, wherein
the program includes a program for causing the system to display a status regarding availability for use for each of the candidate destinations.

8. A graphical user interface for a distributed printing system equipped with a display, the system being capable of distributing print jobs to a plurality of printing apparatuses connected to a network, comprising:
a distribution destination candidate display zone that displays candidate destinations selected from the plurality of printing apparatuses as candidates of destination of the distribution of the print jobs, wherein
the distribution destination candidate display zone displays a status regarding availability for use for each of the candidate destinations.

9. A control method for a distributed printing system equipped with a display, the system being capable of distributing print jobs to a plurality of printing apparatuses connected to a network, comprising:
a candidate destination display control step of displaying candidate destinations selected from the plurality of printing apparatuses as candidates of destination of the distribution of the print jobs, wherein
the control method comprises the steps of:
allowing a user input for specifying at least one of the candidate destinations displayed on the display and for causing an execution of a warm-up process of the specified the candidate destinations; and
controlling the specified the candidate destinations to execute the warm-up process in response to the user input.

10. The control method according to claim 9, further comprising
the step of maintaining a connection to the specified candidate destinations since the user input until a submission of the print job.

11. A control apparatus for a distributed printing system equipped with a display, the system being capable of distributing print jobs to a plurality of printing apparatuses connected to a network, comprising:
a candidate destination display controller that displays candidate destinations selected from the plurality of printing apparatuses as candidates of destination of the distribution of the print jobs, wherein
the distribution destination candidate display controller is configured to allow a user input for specifying at least one of the candidate destinations displayed on the display and causing an execution of a warm-up process of the specified distribution destination candidate printing apparatuses, wherein
the control apparatus is configured to control the specified candidate destinations to execute the warm-up process in response to the user input.

12. A graphical user interface for a distributed printing system equipped with a display, the system being capable of distributing print jobs to a plurality of printing apparatuses connected to a network, comprising:
a candidate destination display controller zone displays candidate destinations selected from the plurality of printing apparatuses as candidates of destination of the distribution of the print jobs, wherein
the distribution destination candidate display zone is configured to allow a user input for specifying at least one of the candidate destinations displayed on the display and causing an execution of a warm-up process of the specified distribution destination candidate printing apparatuses.

13. A control method for a distributed printing system equipped with a display, the system being capable of distributing print jobs to a plurality of printing apparatuses connected to a network, comprising:
a distributor information display step of displaying distributor-information for identifying a distributing printing apparatus selected by a user from the plurality of printing apparatuses, the distributing printing apparatus being a distributor of the print jobs in the distributed printing system;
a competent destination information display step of displaying competent-information for identifying printing apparatuses capable of printing functions available in the distributing printing apparatus as competent destinations for a user selection; and
a candidate destination information display step of displaying candidate-information for identifying candidate destinations selected by the user from among the competent destinations, the candidate destinations being destinations of the distributed print jobs.

14. The control method according to claim 13, wherein
the competent destination information display step includes the step of displaying at least one printing apparatus of the same type as the distributing printing apparatus.

15. The control method according to claim 13, wherein
the control method is configured to display the distributor-information, the competent-information, and the candidate-information in a common window.

16. The control method according to claim 13, wherein
the control method is configured to display the candidate-information in an order of priority levels as the candidate destinations determined by the user.

17. The control method according to claim 13, wherein
the control method is configured to allow a user input for selecting a distribution method from available distribution methods including a first method and a second method, the first method being configured to send the print job including a calculated copy number to each of the candidate destinations, the second method being configured to keep sending the print job including a copy number of one to each of t the candidate destinations until a required total number of copy is printed, the calculated copy number being calculated by dividing the required total number with the number of the candidate destinations.

18. The control method according to claim 13, wherein
the control method is configured to allow a user input for adding a provided specific condition for automatically selecting the competent destinations.

19. A control apparatus for a distributed printing system equipped with a display, the system being capable of distributing print jobs to a plurality of printing apparatuses connected to a network, comprising:
a distributor information display controller that displays distributor-information for identifying a distributing printing apparatus selected by a user from the plurality of printing apparatuses;
a competent destination information display controller that displays competent-information for identifying printing apparatuses capable of printing functions available in the distributing printing apparatus as competent destinations for a user selection; and
a candidate destination information controller that displays candidate-information for identifying the candidate destinations selected by the user from among the competent destinations.

20. A computer program product for causing a distributed printing system equipped with a display, the system being capable of distributing print jobs to a plurality of printing apparatuses connected to a network, the computer program product comprising:
a computer readable medium; and
a computer program stored on the computer readable medium, the computer program comprising a program for causing the system to display candidate destinations selected from the plurality of printing apparatuses as candidates of destination of the distribution of the print jobs, wherein
the program includes a program for causing the system to display a status regarding availability for use for each of the candidate destinations.

21. A graphical user interface for a distributed printing system equipped with a display, the system being capable of distributing print jobs to a plurality of printing apparatuses connected to a network, comprising:
a distributor information display zone that displays distributor-information for identifying a distributing printing apparatus selected by a user from the plurality of printing apparatuses;
a competent destination information display zone that displays competent-information for identifying printing apparatuses capable of printing functions available in the distributing printing apparatus as competent destinations for a user selection; and
a candidate destination information zone that displays candidate-information for identifying the candidate destinations selected by the user from among the competent destinations.
